(19) United States
(12) Patent Application Publication
(10) Pub. No.: US 2002/0007687 A1
(43) Pub. Date: Jan. 24, 2002

(54) Method for detecting trace substances and/or environmental properties

(76) Inventors: Ralf Zimmermann, Munchen (DE); Antonius Kettrup, Arnsberg (DE)

Correspondence Address: Klaus J. Bach, 4407 Twin Oaks Drive, Murrysville, PA, 15668, US

(21) Appl. No.: 09/945,434

(22) Filed: Sep. 4, 2001

Related U.S. Application Data
(63) Continuation-in-part of application No. PCT/EP00/01501, filed on Feb. 24, 2000.

(30) Foreign Application Priority Data
Mar. 24, 1999 (DE) 199 13 220.8

(51) Int. Cl. G01N 1/04; G01N 1/00

(52) U.S. Cl. 73/864.71; 73/864

(57) ABSTRACT

In a method for detecting trace substances or environmental properties, wherein a collection structure including a collection-active material is layed out following a predetermined pattern, and, after a certain exposure time, the collection structure is reeled in and the collection structure is analyzed in a location-dependent manner, the analysis values are correlated with the layout pattern of the collection structure to establish an analysis value pattern over the area in which the collection structure was layed out.

This is a Continuation-In-Part application of international application PCT/EP00/01501 filed Feb. 24, 2000 and claiming the priority of German application 199 13 220.8 filed Mar. 24, 1999.

### BACKGROUND OF THE INVENTION

The invention resides in a method for detecting trace substances and/or environmental properties.

The composition of the fraction of highly- and medium-volatile compounds as a function of the location can provide information concerning for example substances hidden below ground. With this search principle for example, especially trained dogs can search for hidden objects such as mines or drugs. If, for example, old ground contamination sites are searched for, soil samples are taken following a certain search scheme which samples are then tested in a chemical laboratory for explosive residues or polycyclic aromatic compounds (PAK).

No systems are in existence for the rapid testing and automatic analysis of large areas. If in a certain area contamination are suspected samples (for example soil samples) are taken. These samples are taken to a chemical laboratory and their contents are extracted by solvents. The extract is then pre-cleaned (“clean-up step”) and concentrated. Then the chemical substances are analyzed in an analytical procedure using for example gas chromatography-mass spectrometry (GC-MS). For determining the concentration of compounds contained in the air, usually active collection procedures are used, which conduct a certain volume flow of air to be analyzed over a collection unit (for example, adsorption tubes filled with activated carbon or through an impinger filled with a solvent for absorption. Passive collection units are used, for example, for the long term surveillance of exhaust gases (emission surveillance).

A rapid method for the analysis of air samples is the thermodesorption [1] of the collection medium. In this method, the gaseous compounds desorbed from the collection medium are transferred directly to a trace element analysis instrument. For highly volatile compounds, for example, various activated carbon modification (for example, Carbotrap) or resins (for example, TENAX) [2] have been found to be effective. For the thermodesorption analysis of less volatile compounds, for example, collection units of silicon rubber are suitable [3], [4].

Direct methods for determining the concentration distribution of chemical compounds in an area exist in principle (for example, LIDAR). However, they are generally too insensitive and unspecific to be useable for an indirect detection of hidden objects.

It is the object of the present invention to provide a method for detecting hidden chemical compounds, which method is fast and with which the location of the hidden chemicals is clearly indicated.

### SUMMARY OF THE INVENTION

In a method for detecting trace substances or environmental properties, wherein a collection structure including a collection-active material is layed out following a predetermined pattern, and, after a certain exposure time, the collection structure is reeled in and the collection structure is analyzed in a location-dependent manner, the analysis values are correlated with the layout pattern of the collection structure to establish an analysis value pattern over the area in which the collection structure was layed out.

Various embodiments of the invention will be described below on the basis of the accompanying drawings.

### BRIEF DESCRIPTION OF THE DRAWINGS

FIG. 1 shows the layout of the collecting structure,

FIGS. 2a-2e show various configurations of the collecting structure,

FIG. 3 shows the coordination of the compound concentration and location,

FIGS. 4a and 4b show two possible arrangement schemes for the collecting structure for searching for explosives and land mines, and

FIG. 5 shows a vehicle for installing the collection structure in the ground.

### DESCRIPTION OF PREFERRED EMBODIMENTS

A rope-like collecting structure 1 is arranged on the area to be examined according to a certain pattern. The rope-like collecting structure 1 consists totally or partially of a substance 2 which is capable of adsorbing, collecting or enriching certain ambient compounds or reacting to ambient compounds. After a certain exposure period, volatile organic compounds have been collected and are enriched on the collection structure, in accordance with their local ambient concentration. After reeling in the rope, the concentration of the compounds on the rope can be determined in an automatic analyzing instrument 5 as a function of the position on the rope. If the chemical information 6 along the collection rope is combined with the lay-out pattern of the rope, a map of the chemical information is obtained. Depending on the area of application, the chemical information may indicate numeral deposits or soil contamination sites. It is important for an economical utilization to employ an inexpensive collection medium which is available in large amounts and which has suitable physical properties (for example, high strength). Coated or uncoated polymer ropes for example of nylon may be used.

Method for the location-determined detection of gaseous or dissolved trace compounds: Concept

By placing a flexible band or rope-like collection structure in accordance with a certain scheme on a surface to be examined, information concerning the area being examined are collected during the exposure time. The band or rope-like collection structure is suitable for the adsorption and/or absorption of the trace compounds to be investigated or for the chemical or biological conversion of the trace compounds to be detected or for the chemical, physical at biological indication of physical, chemical or biological properties and, consequently, serves as a passive collector/indicator for volatile organic or inorganic compounds or other environmental conditions.

In principle, there are two possibilities:

1. When the band or rope-like collection structure is layed out as “location-identifying chemical collector”, compounds of the ambience are attached to the collection structure 2 or, respectively, enriched thereon. This occurs by adsorption or absorption (physical or chemical sorption). The analytes collected on the collection structure are determined after the reeling in of the collection structure in an analytical detection step in a location-indicative manner.

2. When the band- or rope-like collection structure is layed out as location determining indicator, properties of the band- or rope-like collection structures 1 are determined which properties may have changed as a result of ambient influences. For example, chemical biological or physical indicators can be integrated into the collection band or rope.

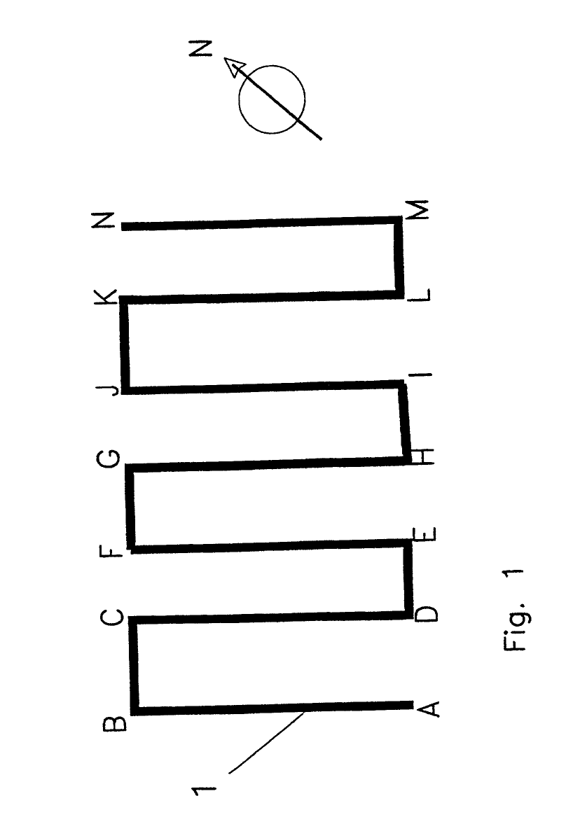

Analytes out of the air (or of the water) above the surface area are concentrated. The defined localized definition then permits the determination of the average concentration depending on the location in the area. FIG. 1 shows schematically how the collecting structure 1 may be layed out on a certain area (field, plant area, etc.) for the detection of, for example, hidden contamination sites (for example, old contamination sites and production residues), military material (mines) or deposits of fossil fuels. The collected compounds can be analyzed as a function of their location on the collection structure 1. The analysis can be performed by a number of different processes. Particularly suitable are, in this connection, on-line measuring procedures, which permit a direct analysis of compounds as a function of the location on the collection structure 1. A number of suitable on-line measuring methods are described in [5] and [6]. On the basis of the position correlation, the concentration of the chemical compounds in the air/soil area of the examined area can be established.

Detailed Description of the Components

a) the collection structure

The collection structure 1 includes a collection-active substance 2, which may be modified depending on the desired application so that it can be used for a multitude of analytes.

The collection is achieved by adsorption, by absorption or by chemical reaction. In the Solid Phase Micro Extraction (SPME) Technique for the gas chromatography, it has been shown what high enrichment factors can be achieved with a passive collection method: On a 10 mm long quartz fiber with a 10-100 μm thick coating of, for example, phenylsiloxane, compounds can be accumulated in a short period of time which compounds can then be detected in the GC. The Detection limits for chemical compounds are often in the ppt-range or better.

As collection-active substances 2, for example, polymers may be used and also coatings, which are used in the gas chromatography as stationary phases. Examples are polyacrylate, polysiloxan, polydimethylsiloxan, phenylsiloxan, methylsiloxan or carbonwax. Furthermore, also, polymers such as teflon, nylon etc. are suitable.

Non-polar compounds are collected by diffusion into the collection substance and dissolution in non-polar media such as silicon. For example, a perlon rope coated with silicon may be used for the collection of non-polar medium-volatile analytes. Silicon is particularly suitable for the collection of medium volatile compounds. If, for example, highly volatile compounds should also be collected, another substance such as activated carbon powder (carbotrap) may be admixed to the silicon. Alternately, a silicon-coated carbon fiber may be used.

Polar organic compounds require other collection media (which themselves are polar), for example, siloxan phases into which cyanide groups (—CN) were introduced or to which corresponding collection active compounds were admixed to form a silicon matrix.

Ionic compounds or metal ions can be collected from the aqueous phase (taking water samples or soil samples) in accordance with the principle of ion exchange. It is therefore possible to use ropes coated with ion exchange resins for a localized detection of ions.

Depending on the type of the chemical substances to be collected and analyzed specific collection media can be developed which contain chemical or biological reaction agents. For collecting ionic compounds, which are polarized or can be polarized, for example, complex-forming compounds (such as chelate-formers like EDTA for metal ions) may be used in a matrix.

Reaction agents which are inserted into the collection structure 1 and which react with certain analytes and thereby change the absorption photometric properties (color reaction agents) or the fluorescence properties (fluorescence markers) can be used. The collection structure 1 can then be simply and rapidly scanned by spectroscopic detection (1R and UV/VIS absorption/reflection, luminescence detection, etc.). After such a non-destructive examination, the collection rope 1 may be subjected to further analysis procedures.

With biological reaction agents antibody-based processes may be used for example (see the Immuno Essay process). If live microorganisms or spores (bacteria, fungi, algae or other single cell organisms) are inserted into the collection structure 1 (or attached thereto), a location-dependent “ecotoxicological” test may be performed, wherein the products of the metabolism, the growth or the dying off or other properties of the cells are examined. Depending on the enzymatic provisions for the microorganisms, a specific detection of certain essential or toxic compounds can be achieved. (Some bacteria consume for example H₂S or certain metals or they require a certain pH value or a certain O₂ concentration for growth. In addition, particular strains may be used which are particularly sensitive with regard to a certain xenobioticum.

The locally collected compounds may also be detected by way of an external immunological or biological method. The collection structure 1 may be contacted by another medium so that reaction agents and/or analytes can be exchanged between the media while maintaining the position indication (for example, the transfer to immuno-essay carrier plates etc.). Alternatively, the collection rope 1 may, in sections, also be wet-chemically extracted and then subjected to a chemical, biological, physical or immunological analysis.

Furthermore, more recent techniques, which are based on an artificial production of receptors (for example, molecular imprinting), may be used [8].

If several specifically prepared rope or fiber-like collection structures [1] are used, they can be combined in a bundle. If the fibers consist of different collection-active substances 2 or if they are differently coated, many different analytes (also chemically different ones: for example, polar and non-polar compounds) can be collected at the same time. Furthermore, such “multi fiber collection structures can be used for covering large concentration ranges of the analytes since quantitative results can be obtained with each collection medium only for a certain concentration range.

If the active collection material is applied to the underside of a strip or the rope is covered by a strip of, for example, plastic, the chemical information permeating from the ground below cannot be veiled by wind etc. . . .

The exposure time is to be selected depending on the expected concentration range and will usually be in the area of hours or days. After the exposure period has passed the collecting structure is reeled in.

It may be advantageous for a field application of the method if the collecting structure 1 develops its collection effectiveness only when being layed out in order to prevent contaminations. Similarly, the collecting structure 1 could be de-activated after being reeled in and before analysis (for example, when it needs to be stored). This can be achieved by using an elastic collection structure 1, which consists of a collection active core and a coating, which is impervious or almost impervious for the compound to be analyzed. For taking samples, the collection structure may then be stretched whereby the coating becomes pervious for certain analytes. When contracted, for example, during transport to the analysis apparatus or during storage the structure is less pervious for the analyte.

It is advantageous if, after collection of the information, the collecting structure is so treated that the information remains unchanged. This can be achieved for example, by storing the collecting structure under cooling or in an inert atmosphere. Furthermore, the information may be fixed for example by chemical reactions. Also, the collecting structure may be coated with an impervious layer. A coating apparatus may be integrated into a device with which the collecting structure is reeled in.

b. The analysis apparatus

The information present on the collecting structure 1 in a location-dependent manner must be examined by a suitable analysis process. In order to utilize the process for the examination of large areas, it is not only necessary to provide an inexpensive collection structure, but the analysis should also be fast and automatic. Ideally the analysis apparatus 5 should reel in the collection structure 1 and at the same time analyze the information on the collection structure in a location-dependent manner.

In principle, there are two analysis methods.

1. The compounds collected in the collection structure or the changes in the collection structure 1 are detected directly in the collection structure 1. For example, a collection rope 1 can be exposed, in sections, to laser light. Any aromatic compounds collected by the collecting structure are then indicated by the fluorescence light emitted thereby.

2. The (chemical) information is transferred to another medium before the analysis. For example, a collection rope may be pulled through a thermo-desorption unit. In the process, the collected chemical compounds are transferred to the gas phase and are continuously recorded by an on-line analytical method such has REMPI-TOFMS.

If non-destructive detection and analysis processes are used, different detection process may be employed one after another.

Before or after a thermodesorption, the analytes may be determined, for example, by the following processes:

UV-VIS (absorption spectroscopy)

Fluorescence spectroscopy

IR (infra red absorption spectrometry)

Ramon spectroscopy

NMR (nuclear resonance spectrometry)

Fluor-ionization detector (FID)

Electron captive detector (ECD)

X-ray fluorescence spectroscopy

Ion mobility spectometry [9]

Electronic noses [10] or sensors [11]

AAS (atom absorption spectrometry)

Laser spectroscopic procedures

Mass spectrometric processes

Laser spectroscopic processes, for example, laser-induced fluorescence (LIF), laser-induced plasma spectrometry (Laser Induced Plasma Spectroscopy (LIPS) for the detection of elements) or photo-acoustic spectroscopy provide often for detection with particularly high selectivity. Below, as examples, some possible detection methods are presented in greater detail. The collection structure may be drawn through a special thermo-desorption unit for analysis, wherein the location dependent chemical information on the rope-like collection structure is transferred to a corresponding time-dependent information in a carrier gas flowing through the thermo-desorption unit (thermo desorption (TD) of the analytes). This time-dependent chemical information contained in the gas flow is detected by an analyzing apparatus or detector in a time dependent fashion. A newer highly sensitive and selective method for the trace detection of, for example, aromatic compounds of the TD gas flow is the Resonance Enhanced Multi-Photon Ionization (REMPI) with subsequent travel time mass analysis (TOFMS). The detection occurs, for example, by way of an automatic thermodesorption unit (TD unit), which is connected on-line to a REMPI-TOFMS spectrometer. The automatic TD unit reels the collection structure automatically in. The collection structure is pulled for example through a 150 to 300° hot glass tube wherein the collection structure is locally heated. At the same time, a sampling gas flow of relatively low speed (for example, 0.1-10 ml/min) is established through the glass tube past the locally heated collection structure and carries the thermically desorbed compounds away. By way of a direct inlet, the sample gas stream is then conducted directly to the REMPI-TOFMS spectrometer. For the inlet possibilities for REMPI-TOFMS see references [12]. Since the detection sensitivity for many aromatic systems is in the pptv concentration range, the detection sensitivity is very high. Furthermore, on-line derivation steps may be used for REMPI-TOFMS for the detection of certain compounds [13]. If the sensitivity for certain indicator or target compounds should be insufficient a further enrichment could be obtained, however with a concurrent reduction in location definition.

In this procedure, the collected compounds of a certain length of the collection structure 1 are analyzed in an integrative manner. This may be achieved practically with a reel onto which a certain length of the collection structure is wound. Then follows a simultaneous thermal desorption (and subsequently the analysis of the analytes) of the reeled up collection structure. Subsequently, the collection structure is unreeled and the next length of the not yet analyzed collection structure is reeled up, thermo-desorbed etc,. Alternatively, with continuous thermo-desorption, a cold trap, which can be thermo-desorbed, can be installed in the gas stream receiving the sample.

The desorption of the chemical compounds, which are collected on the rope-like collecting structure can be achieved during the analysis in the sampling device of an analysis apparatus by irradiation with laser pulses. This laser desorption of the analytes can be performed directly in the evacuated area of a mass spectrometer. If the collection structure is pulled automatically through the analysis apparatus the procedure corresponds to a type of on-line MALDI [14]- or laser-microprobe analysis (LAMMA) [15]. A suitable MALDI matrix can be included in the collection area. Alternatively, the laser may be used only for the desorption whereas ionization is achieved by another method (REMPI, EI, FAB etc.) [16].

### DESCRIPTION OF APPLICATION EXAMPLES

The method has a multitude of possible applications. The location-based detection of organic and inorganic can be employed for example for the following purposes:

Locating old contaminations such as productions residues of former fabricating plant sites (BTX, PAK, heavy metals, PCK etc.).

Detection of military contaminations such as production residue, explosive materials, mines (for example, TNT, ROX etc.)

Forensic application, for example, for the targeted search for drugs or corpses.

detection of geological deposits for example natural gas, crude oil (by way of hydrocarbon) or ores (for example, by way of metal ions)

determination of concentration profiles of chemical compounds within industrial installations or along pipelines, for example, for the detection of leaks.

determination of anthropogenic or bio/geogenic emissions or emission concentrations of chemical substances or other chemical, physical or biological properties in water, land (soil) or air (for example, long-term surveillance of volcanic or earthquake activities by a recording of volcanic gases such as H₂S or CO₂, determination of the biogenic area emissions of CH₄, N₂O etc.).

Below, some applications are discussed in greater detail.

a) Detection of chemical contaminations and manufacturing residues.

By laying out a flexible band-or-rope-like collecting structure as a passive collector for volatile organic or inorganic compounds in a predetermined arrangement over a surface area to be examined, analytes from the air (or of water) above this surface area are collected. the defined position arrangement permits to determine the concentration as a function of the position of the particular section of the band or rope during the later analysis. FIG. 1 shows schematically the lay-out scheme for the collection structure 1 for example on a former manufacturing site for the detection of a hidden mineral oil-based contamination. For the detection of mineral oil-based contaminations, monocyclic aromats such as benzene, toluene, and xylol (BTX) or smaller polycyclic aromatic hydrocarbons such as napthalene, mono and dimethyl napthalene, acenaphtene, fluorene, biphenyl or anthracene are suitable indicators. As collection medium a multitude of media may be used. For example, a perlon string coated with silicon may be used. Since silicon is suitable primarily for the detection of medium soluble components, it may be advantageous to admix media for the absorption of highly volatile compounds (for example, finely ground Carbotrap or TENAX). Alternatively, a silicon-coated carbon fiber could be used. Also a bundle of several collection-active fibers could be combined. If the fiber consists of different collection-active substances, a relatively large concentration range of the analyte substance can be determined since quantitative examination results can be obtained for each collection medium only in a certain concentration range. If the collection-active material is disposed only on the under side of a band or the layed out rope is covered by a band of, for example, elastic material, the information emanating from the ground cannot be veiled by wind etc. The exposure period is to be selected depending on the collection or detection process and the expected concentration range of the analyte. It is generally in the area of hours to days. After the exposure period, the collecting structure is reeled in. The chemical substances can be analyzed by a multitude of methods. Aromatic compounds such as BTX or PAK can be detected easily for example by resonance amplified milliphoton ionization travel time mass spectrometry (REMPI-TOFMS). A relatively universal method for the detection of volatile compounds is the mass spectrometry with a C1-ion source (for example, PTR-MS [17]. Other detection methods have been described earlier.

b) Detection of military contaminations, explosives, chemical warfare material or mines.

The method may also be used for the location-based detection of military contaminations, explosives, chemical warfare materials or mines. The detection of military contaminations such as production residues of the TNT production or the manufacture of chemical materials is particularly important in the densely populated areas of central Europe (for example of heightened importance in Eastern Europe). For the detection of former TNT production sites, a simple ECD (Electron Capture Detector) may be sufficient or a thermionic detector (TID; nitrogen and phosphorus selective) [18] for reading the chemical information on the collection rope. Otherwise, a multitude of different detection principles may be utilized (for example, REMPI-TOFMS, IMS, electronic sensors, PTR-MS). Element-specific detectors such as an atom emission detector (AED) or a TID (for nitrogen and phosphorus [18] may also be used for the detection of chemical warfare materials.

Particularly problematic is the detection of mines, specifically anti-person mines. Many countries of Asia, Africa, partially also South America and even Europe (Bosnia) have large land areas with hidden anti-person mines. The removal of mines is very dangerous since an accurate locating of the mines by technical means is not possible. New types of anti-person mines use practically no metal parts so that metal detectors cannot detect them. Trained dogs have however been used successfully as they can smell the mines. The odor bouquet comprises TNT or RDX traces as well as the de-composition products thereof (for example, di- and mono-nitrotoluene, aminotoluene, etc.). Furthermore, it is possible for the dogs to detect characteristic secondary compounds such as solvent residues, plasticizer from the plastic casing, resin decomposition products (monomers, etc) of the mines, which are buried typically 0-20 cm deep. The use of dogs, however, is complicated and slow. In order to examine large areas or to locate individual mines the method proposed herein could be utilized. The collection rope 1 could be deployed in many ways. One possibility is the use of clean up vehicles to establish safe paths between, which then collection ropes could be layed out at a distance of, for example, 5 or 10 m from one another. For inaccessible areas with high mine dangers, guns or cannons could be used which shoot collection ropes across such areas for example by shooting 12 collection ropes radially outwardly from a particular location. With a length of a collection rope of about 60 m, an area of 20,000² could be covered with a minimum resolution of 10 m. The payout apparatus could for example be deposited by a helicopter and could later again be picked up by the helicopter. It is important for any laying out procedure that the position of the collection ropes 1 is reproducibly determined. This can be achieved by aerial photography or by satellite orientation.

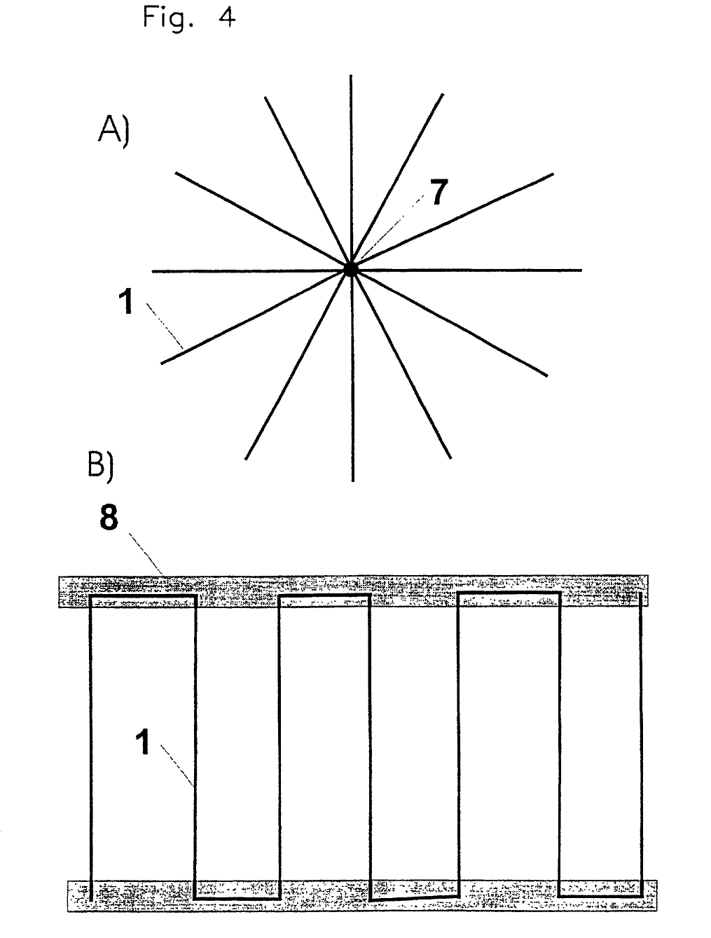

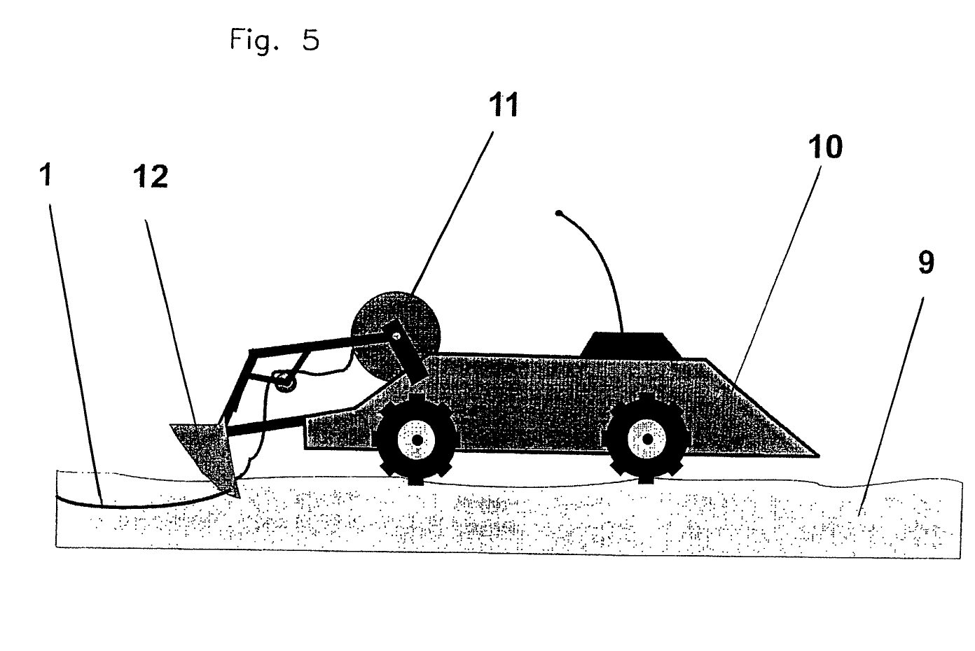

FIGS. 4 and 5 show two possible method for paying out the ropes for searching for mines. It may be necessary to bury the collection rope in a groove, which is again covered by soil. This could be done by a remotely controlled payout vehicle 10 as shown in FIG. 5.

Since the evaporation products of mines are present only in extremely small traces (ppqv or less) an extremely selective and sensitive analysis procedure for the collection structures 1 is required. Several of the analytic techniques described earlier are suitable, in principle, for the analysis of the collection ropes 1. The REMPI-technique or IMS, for example are suitable for the detection of nitro-aromates by way of the NO⁺ ion in the mass spectrum. In addition, or alternatively to an instrument detection, the identification of the mine “bouquet” according to the “Sniffing detection with the GC can also be taken on by trained dogs. (TD-Gas stream). With a low stimulus-environment (boxes) and the use of token systems the senses of the trained animals may be concentrated onto the task. Collection ropes 1 may also be used for a surveillance of chemical plants. In this way, it could be determined whether production restrictions for chemical warfare materials or rocket fuels or explosives are observed.

c) Detection of deposits of for example fossil fuels or ores.

The method can be used for the detection of mineral deposits, which are disposed sufficiently close to the ground surface. In the search for fossil deposits (oil, gas, coal) organic compounds are looked for (CH₄, BTX, PAK, alkanes or hydrogensulfide). For the collection step of, for example, highly volatile compounds such as H₂S or methane collection structures 1 with high absorption forces must be used (for example, graphite in a silicon matrix on a carrier substance). The detection of the organic compounds then occurs as described earlier. In the search for mineral deposits (cupper, manganese, or uranium ore) generally the respective metal ions from the aqueous phase thereof or from the moist soil are looked for. The search can therefore be performed in principle above or below water level. As collection medium for ionic compounds, ion exchangers are particularly suitable. The detection can be performed using for example the laser spectrometric methods (laser induced plasma spectroscopy, LIPS) or ICP-MS.

### FIGURES

FIG. 1:

The laying out of the rope-like collection structure (passive collector) on the ground in a certain pattern provides for a location based detection of trace compounds.

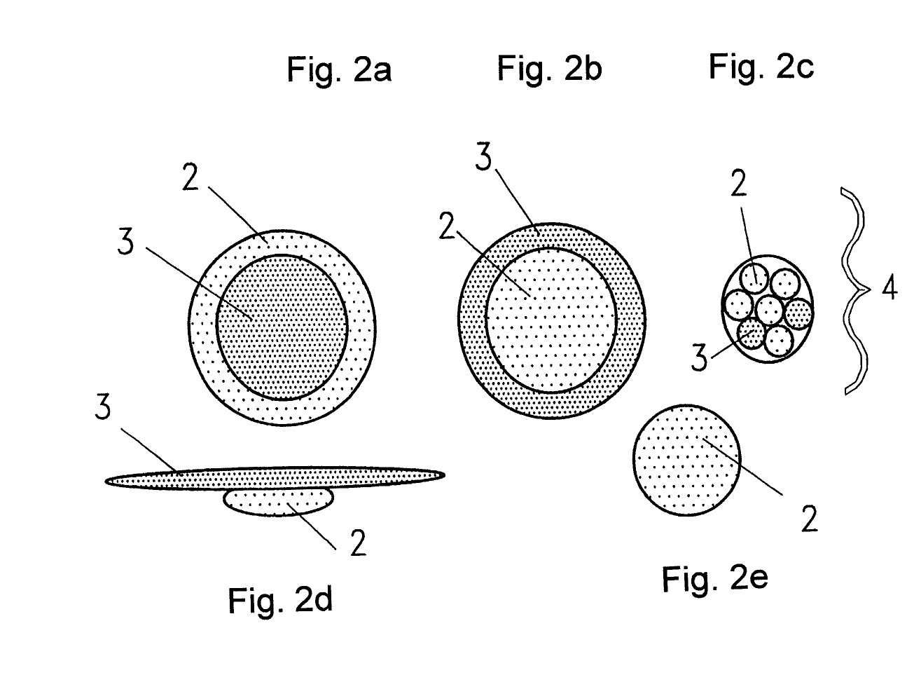

FIGS. 2a-2e:

The collection rope 1 may consist of a support rope 3 (for example, a polymer string or a steel wire), which is coated with one or several layers of the same or different collection-active substances 2, such as silicon, TENAX or activated carbon (FIG. 2a). Alternatively, the collection rope 1 may consist of a collection-active core 2, which is surrounded by a supportive (and protective) medium 3 (FIG. 2b). Different collection-active and supportive fibers 2 and 3 may also be combined to a fiber bundle 4 (FIG. 2c). The support structure may be a band, on one side of which the collection-active substance is disposed (FIG. 2d). The collection structure 1 may also consist only of a collection active material 2 (for example, a polymer rope—FIG. 2e).

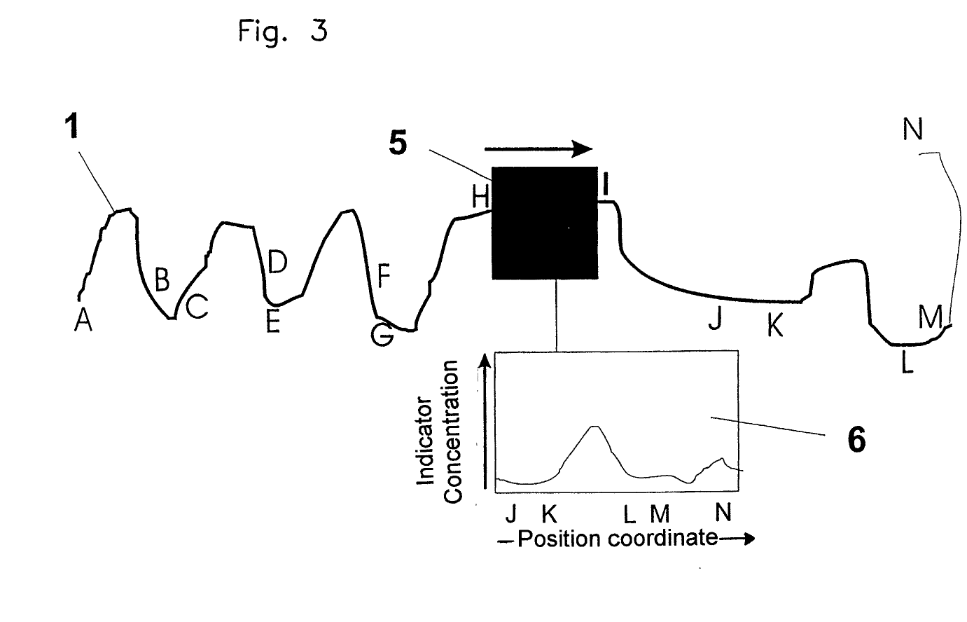

FIG. 3:

The collection structure 1 may be read by an automatic on-line analysis apparatus 5, which automatically reels the collection rope in. The analysis apparatus 5 may be, for example, a thermo-desorption laser mass spectrometry unit (TD-REMPI-TOFMS). The result of the measurement is a location coordinate-concentration diagram 6, which provides for a correlation of the measured values with the location pattern (FIG. 1).

FIG. 4:

With the utilization of the method for the detection of mines or explosives, it is important that the collection ropes 1 can be layed out without endangering any person. It is, for example, possible to lower from the air (helicopter etc. . . ) a unit 7 onto the ground which unit ejects or shoots the collection ropes 1 radially outwardly. After a certain exposure time, the unit can again be retrieved from the air. In accessible areas, parallel paths 8 can be formed by heavy duty machinery and the collection ropes can be extended across the area between the paths.

FIG. 5:

It may be necessary for some applications that the collection rope 1 is buried in grooves cut into the ground 9. To this end, the rope may be layed out by a vehicle 10 including a hollow hook cutting into the ground and, at the same time, paying out the rope from a reel 11 for placement below ground level 9. For an application in the field of mine detection, the vehicle 10 may be operated by remote control.

Listing of literature referred to in the specification:

[1] M. Blumenstock, R. Zimmermann, K.-W. Schramm, A. Kaune, U. Nikolai, D. Lenoir, A. Kettrup, Organohalogen Compounds Vol. 36 (ISBN 91-89192-05-2), Edited by the Swedisch Environmental Protection Agency (1998) 47-52

[2] R. Zimmermann, E. R. Rohwer, H. J. Heger, E. W. Schlag, A. Kettrup, G. Gilch, D. Lenoir, U. Boesl: Resonance Ionization Laser Mass Spectrometry: New Possibilities for On-Line Analysis of Waste Incinerator Emissions, Proceedings of the 8. Resonance Ionization Spectroscopy Symposium 1996, American Institute of Physics (AIP)-Conference Proceedings 388, AIP-Press New York (1997) 123-126

[3] E. K. Ortner, E. R. Rohwer, HRC-J.High Resol. Chromatograph. 19 (1996) 339

[4] R. Zimmermann, U. Boesl, H. J. Heger, E. R. Rohwer, E. K. Ortner, E. W. Schlag, A. Kettrup, Hyphenation of Gas Chromatography and Resonance-Enhanced Laser Mass Spectrometry (REMPI-TOFMS): A Multidimensional Analytical Technique, HRC—J. High Resol. Chromatography 20 (1997) 461-470

[5] G. Matz in “Untersuchung der Praxisanforderung an die Analytik beo der Bekämpfung groβer Chemieunfälle” Zivilschutz-Forschung, Hrsg.: Bundesamt für Zivilschutz, (ISSN 0343-5164), Neue Folge Band 30

[6] H. J. Heger, R. Zimmermann, R. Dorfner, M. Beckmann, H. Griebel, A. Kettrup, U. Boesl, Anal. Chem. 71 (1999) 46

[7] T. Gorecki, J. Pawliszyn, Editors: P. Sandra, G. Devos, Proceedings of the 18^{th} Int. Symposium on Capillary Chromatography 1996, Hüthig Verlag, Heidelberg (1996) 762

[8] T. Takeuchi, D. Fukuma, J. Matsui, Anal Chem. 71 (1999) 285-290

[9] S. D. Huang, L. Kolaitis, D. M. Lubman, Applied Spectroscopy 41 (1987) 1371-1376

[10] Vlasov-Y; Legin-A, FRESENIUS-JOURNAL-OF-ANALYTICAL-CHEMISTRY 361 (1998);: 255-260.

[11] Reibel-J; Stier-S; Voigt-A; Rapp-M, ANAL. CHEM. (1998) 70, 5190-5197.

[12]

a) DE 19539589.1

b) EP 0770870A2

c) DE 9822672.1

d) DE19822674.8

[13] DE 19754151.5 (1997)

[14] F. Hillenkamp, M. Karas, R. C. Bevais, B. T. Chait, Anal Chem 63 (1991) 1196A-1203A

[15] L. Van Vaeck, H. Struyf, W. Van Roy, Fred Adams, Mass Spectrom Reviews. 13 (1994) 198-208; ibid.209-232

[16] L. J. Kovalenko, C. R. Maechling, S. J. Clemett, J.-M. Philippoz, R. N. Zare, C. M. O'D. Alexander, Anal Chem. 64 (1992) 682- 690

[17] A. Hansel, A. Jordan, R. Holzinger, P. Parzeller, W. Vogel, W. Lindinger, Int. J. Mass Spectrom. Ion Processes 149/150 (1995) 609-619

[18] Georg Schwendt, Analytische Chemie, Georg Thieme Verlag Stuttgart, New York, 1995

What is claimed is:

1. A method for detecting trace substances or environmental properties, comprising the following steps:
a) laying out in a predetermined pattern a collecting structure which has a certain extension in at least one dimension and which has a predetermined cross-section,
b) retrieving said collecting structure after a certain time of being exposed to the environment including at least one of the air, water and the soil, and
c) analyzing said collection structure in a location dependent manner and correlating the analysis values with the pattern in which said collection structure was layed out.

2. A method according to claim 1, wherein said collection structure is used for a location-dependent adsorption or absorption of trace elements.

3. A method according to claim 1, wherein said collection structure is used as a location-dependent indicator of local environmental properties.

4. A method according to claim 1, wherein the analysis of said collection structure is performed continuously by an automated analysis apparatus, wherein said collection structure is automatically moved through said analysis apparatus.

5. A method according to claim 1, wherein said collection structure is analyzed in sections of said collection structure of a predetermined length and the analysis information of the collection structure is integrated over said predetermined length and correlated to the respective part of the layout pattern of said collection structure.

6. A method according to claim 1, wherein said collection structure consists of a collection active carrier material such as a polymer string, which is coated with at least one layer of at least one collection-active substance.

7. A method according to claim 6, wherein said collection active substance is at least one of silicon, TENAX and activated carbon.

8. A method according to claim 1, wherein said collection structure consists of a collection-inactive support structure such as a steel wire, which is coated with at least one layer of at least one collection-active substance.

9. A method according to claim 8, wherein said collection-active substance is one of silicon, TENAX and activated carbon.

10. A method according to claim 1, wherein said collection structure consists of a collection-active support structure including a core of at least one collection active substance.

11. A method according to claim 1, wherein said collection structure consists of a collection-inactive carrier structure including a core of at least one collection active substance.

12. A method according to claim 1, wherein said collection structure is provided with microorganisms, which are affected by the substance or environmental condition to be detected such that their growth, their dying off or their metabolism products provide for a location based indication for the presence of chemical or physical properties.

13. The use of the method of claim 1 for the detection of explosives or mines.
